(19) United States
(12) Patent Application Publication
(10) Pub. No.: US 2022/0138637 A1
(43) Pub. Date: May 5, 2022

(54) CONTROL APPARATUS, SYSTEM, AND CONTROL METHOD

(71) Applicant: TOYOTA JIDOSHA KABUSHIKI KAISHA, Toyota-shi Aichi-ken (JP)

(72) Inventors: Tae Sugimura, Miyoshi-shi Aichi-ken (JP); Kenta Miyahara, Toyota-shi Aichi-ken (JP); Ayana Takeshita, Kasugai-shi Aichi-ken (JP); Changyi Luo, Kokubunji-shi Tokyo-to (JP); Yuhei Suzuki, Kariya-shi Aichi-ken (JP); Sachin Ahire, Frisco, TX (US)

(73) Assignee: TOYOTA JIDOSHA KABUSHIKI KAISHA, Toyota-shi Aichi-ken (JP)

(21) Appl. No.: 17/518,843

(22) Filed: Nov. 4, 2021

(30) Foreign Application Priority Data
Nov. 5, 2020 (JP) 2020-185437

(51) Int. Cl. G06Q 10/02; G04F 13/00

(52) U.S. Cl. CPC G06Q 10/02; G06Q 10/1093; G04F 13/00

(57) ABSTRACT

A control apparatus includes: a controller configured to estimate a vacant time period during a period from a first time at which a first user checked-in at an accommodation facility to a second time at which the first user is to check-out from the accommodation facility, the vacant time period being a time period during which the accommodation facility is not used by the first user; and a communication interface configured to transmit vacancy data that indicates the vacant time period estimated by the controller, to a terminal apparatus of at least one second user that is different from the first user.

### CROSS-REFERENCE TO RELATED APPLICATION

This application claims priority to Japanese Patent Application No. 2020-185437, filed on Nov. 5, 2020, the entire contents of which are incorporated herein by reference.

### TECHNICAL FIELD

The present disclosure relates to a control apparatus, a system, and a control method.

### BACKGROUND

Patent Literature (PTL) 1 discloses a vehicle navigation apparatus to be used for reserving a facility from a vehicle.

### CITATION LIST

### Patent Literature

PTL 1: JP 2003-021519 A

### SUMMARY

Generally, a user who has reserved an accommodation facility can use the reserved accommodation facility during a period from a time at which the user checked-in at the accommodation facility to a time at which the user is to check-out from the accommodation facility. However, even during the period in which the user can use the facility, there may be a vacant time period during which the facility is not used by the user for such reasons as that the user is out of the facility or the like. The technology described in PTL 1 gives no consideration to making effective use of such a vacant time period.

It would be helpful to make effective use of a vacant time period at an accommodation facility.

A control apparatus according to the present disclosure includes:

a controller configured to estimate a vacant time period during a period from a first time at which a first user checked-in at an accommodation facility to a second time at which the first user is to check-out from the accommodation facility, the vacant time period being a time period during which the accommodation facility is not used by the first user; and

a communication interface configured to transmit vacancy data that indicates the vacant time period estimated by the controller, to a terminal apparatus of at least one second user that is different from the first user.

A control method according to the present disclosure includes:

estimating, by a control apparatus, a vacant time period during a period from a first time at which a first user checked-in at an accommodation facility to a second time at which the first user is to check-out from the accommodation facility, the vacant time period being a time period during which the accommodation facility is not used by the first user; and

transmitting, from the control apparatus, vacancy data that indicates the estimated vacant time period, to a terminal apparatus of at least one second user that is different from the first user.

The present disclosure enables to make effective use of a vacant time period at an accommodation facility.

### BRIEF DESCRIPTION OF THE DRAWINGS

In the accompanying drawings:

FIG. 1 is a diagram illustrating a configuration of a system according to a first embodiment of the present disclosure;

FIG. 2 is a block diagram illustrating a configuration of a control apparatus according to the first embodiment of the present disclosure;

FIG. 3 is a block diagram illustrating a configuration of a terminal apparatus according to the first embodiment of the present disclosure;

FIG. 4 is a block diagram illustrating a configuration of a vehicle according to the first embodiment of the present disclosure;

FIG. 5 is a flowchart illustrating operations of the system according to the first embodiment of the present disclosure;

FIG. 6 is a table indicating correspondences between attributes and lengths of stay according to the first embodiment of the present disclosure; and

FIG. 7 is a flowchart illustrating operations of a system according to a second embodiment of the present disclosure.

### DETAILED DESCRIPTION

Hereinafter, some embodiments of the present disclosure will be described with reference to the drawings.

In the drawings, the same or corresponding portions are denoted by the same reference numerals. In the descriptions of the embodiments, detailed descriptions of the same or corresponding portions are omitted or simplified, as appropriate.

A first embodiment, an embodiment of the present disclosure, will be described.

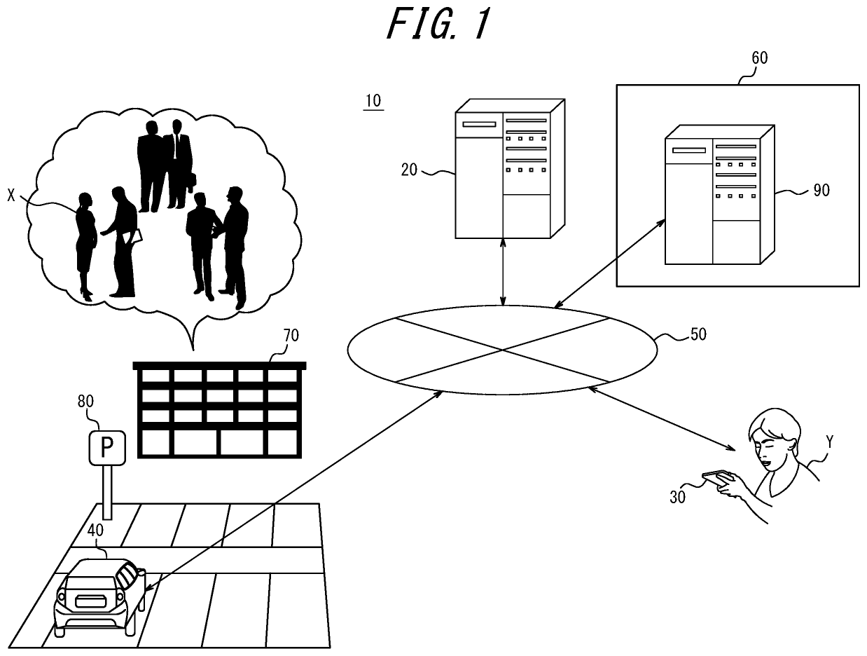

With reference to FIG. 1, a configuration of a system 10 according to the present embodiment will be described .

The system 10 includes a control apparatus 20 and at least one terminal apparatus 30.

The control apparatus 20 can communicate with the terminal apparatus 30 and a management apparatus 90 via a network 50. The terminal apparatus 30 may be able to communicate with a vehicle 40 and the management apparatus 90 via the network 50. The vehicle 40 may be able to communicate with the management apparatus 90 via the network 50.

The network 50 includes the Internet, at least one WAN, at least one MAN, or a combination thereof. The term “WAN” is an abbreviation of wide area network. The term “MAN” is an abbreviation of metropolitan area network. The network 50 may include at least one wireless network, at least one optical network, or a combination thereof. The wireless network is, for example, an ad hoc network, a cellular network, a wireless LAN, a satellite communication network, or a terrestrial microwave network. The term “LAN” is an abbreviation of local area network.

The control apparatus 20 is installed in a facility such as a data center. The control apparatus 20 is, for example, a server that belongs to a cloud computing system or another type of computing system.

The vehicle 40 is used by a first user X. In the present embodiment, the vehicle 40 is a private car owned by the first user X. The vehicle 40 is, for example, any type of automobile such as a gasoline vehicle, a diesel vehicle, an HEV, a PHEV, a BEV, or an FCEV. The term “HEV” is an abbreviation of hybrid electric vehicle. The term “PHEV” is an abbreviation of plug-in hybrid electric vehicle. The term “BEV” is an abbreviation of battery electric vehicle. The term “FCEV” is an abbreviation of fuel cell electric vehicle. The vehicle 40 is driven by the first user X as a driver in the present embodiment, but the driving may be automated at any level. The level of automation is, for example, any one of Level 1 to Level 5 according to the level classification defined by the SAE. The name “SAE” is an abbreviation of Society of Automotive Engineers. The vehicle 40 may be a MaaS-dedicated vehicle. The term “MaaS” is an abbreviation of Mobility as a Service.

The terminal apparatus 30 is held by a second user Y. The second user Y is a user different from the first user X. The terminal apparatus 30 is, for example, a mobile device such as a mobile phone, a smartphone, or a tablet, or a PC. The term “PC” is an abbreviation of personal computer. The terminal apparatus 30 receives data from the control apparatus 20, and presents the contents of the received data to the second user Y.

In the present embodiment, the second user Y is selected from among one or more users. As the second user Y, one user may be selected or two or more users may be selected. In a case in which two or more users are selected, each one of the terminal apparatuses individually held by the selected users corresponds to the terminal apparatus 30.

The management apparatus 90 is installed in the accommodation facility 60. In the present embodiment, the management apparatus 90 is a server or terminal that manages reservations from applicants who wish to use the accommodation facility 60. As a variation of the present embodiment, the management apparatus 90 may be configured as a server installed in other locations than the accommodation facility 60, instead of being configured as a server or terminal installed in the accommodation facility 60. Alternatively, the management apparatus 90 may be configured as a terminal held by an employee of the accommodation facility 60.

The accommodation facility 60 is used by the first user X. In the present embodiment, the accommodation facility 60 is a hotel reserved by the first user X. A conference center 70 is located at a location accessible by the vehicle 40 from the accommodation facility 60. The conference center 70 has a parking lot 80 annexed thereto, in which the vehicle 40 can be parked.

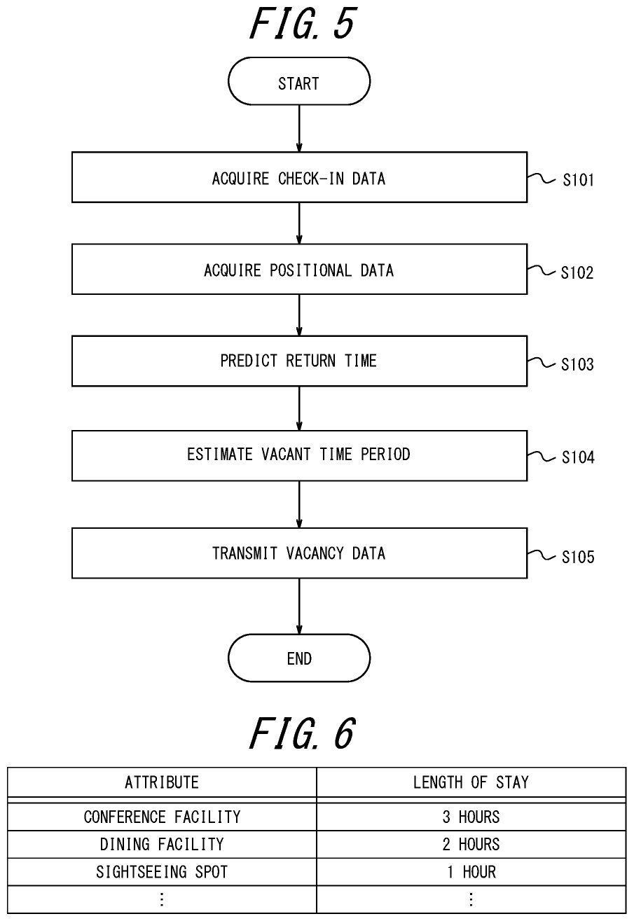

With reference to FIGS. 1 and 5, an outline of the present embodiment will be described.

In the system 10 of the present embodiment, the control apparatus 20 estimates a vacant time period during a period P from a first time at which the first user X checked-in at the accommodation facility 60 to a second time at which the first user X is to check-out from the accommodation facility 60, the vacant time period being a time period during which the accommodation facility 60 is not used by the first user X. The control apparatus 20 transmits, to the terminal apparatus 30 of at least one second user Y different from the first user X, vacancy data that indicates the estimated vacant time period.

The present embodiment enables to make effective use of the vacant time period at the accommodation facility 60.

In the present embodiment, when the first user X arrives at the accommodation facility 60 and reports at the reception, the first user X is deemed as having “checked-in”. The first user X can use the accommodation facility 60 from a “first time” that is a time at which the user checked-in.

In the present embodiment, when the first user X performs a procedure for settling fees such as a usage fee to the accommodation facility 60, the first user X is deemed as having “checked-out”. The first user X can use the accommodation facility 60 until a “second time” that is a time at which the first user X is to check-out. The “second time” may be the date and time designated by the first user X at the time of reservation or check-in, or may be the time designated in advance by the accommodation facility 60 as the standard check-out time on the last day of the scheduled stay period declared by the first user X at the time of reservation or check-in.

In the present embodiment, when first user X goes out from the accommodation facility 60 after the first user X checked-in at the accommodation facility 60, the time period until the first user X returns to the accommodation facility 60 is treated as the “vacant time period”. The second user Y can use the accommodation facility 60 only during the “vacant time period”. In the present embodiment, when the first user X is staying inside a hotel as the accommodation facility 60, the accommodation facility 60 is deemed as being used by the first user X. On the other hand, when the first user X is outside the hotel, the accommodation facility 60 is deemed as not being used by the first user X. As a variation of the present embodiment, even when the first user X is staying inside the hotel, the accommodation facility 60 may be deemed as not being used by the first user X in a case in which the first user X is outside the room assigned to the first user X at the time of reservation or check-in. Examples of the room include a guest room, a business center, a banquet hall, and a restaurant.

In the present embodiment, the vacancy data includes data that indicates a name and location of the accommodation facility 60, a route to the location, and contact information, in addition to data that indicates the start time and end time of the vacant period. The vacancy data may include data that indicates the fee for using the accommodation facility 60 and the number of people who can use the accommodation facility 60, during the vacant time period.

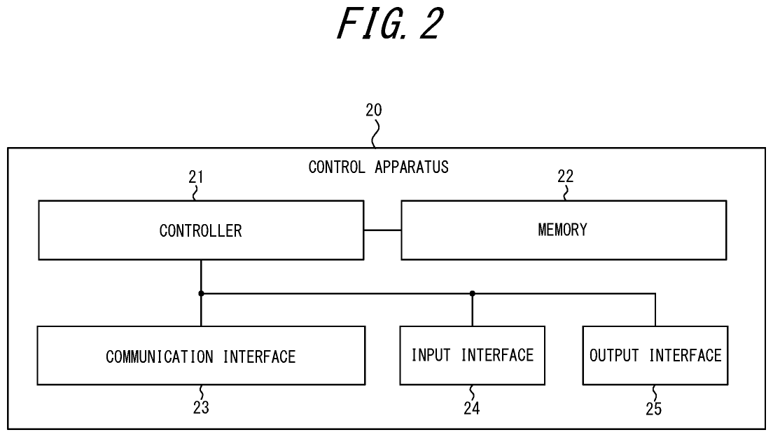

With reference to FIG. 2, a configuration of the control apparatus 20 according to the present embodiment will be described.

The control apparatus 20 includes a controller 21, a memory 22, a communication interface 23, an input interface 24, and an output interface 25.

The controller 21 includes at least one processor, at least one programmable circuit, at least one dedicated circuit, or a combination thereof. The processor is a general purpose processor such as a CPU or a GPU, or a dedicated processor that is dedicated to specific processing. The term “CPU” is an abbreviation of central processing unit. The term “GPU” is an abbreviation of graphics processing unit. The programmable circuit is, for example, an FPGA. The term “FPGA” is an abbreviation of field-programmable gate array. The dedicated circuit is, for example, an ASIC. The term “ASIC” is an abbreviation of application specific integrated circuit. The controller 21 executes processes related to operations of the control apparatus 20 while controlling components of the control apparatus 20.

The memory 22 includes at least one semiconductor memory, at least one magnetic memory, at least one optical memory, or a combination of at least two of these. The semiconductor memory is, for example, RAM or ROM. The term “RAM” is an abbreviation of random access memory. The term “ROM” is an abbreviation of read only memory. The RAM is, for example, SRAM or DRAM. The term “SRAM” is an abbreviation of static random access memory. The term “DRAM” is an abbreviation of dynamic random access memory. The ROM is, for example, EEPROM. The term “EEPROM” is an abbreviation of electrically erasable programmable read only memory. The memory 22 functions as, for example, a main memory, an auxiliary memory, or a cache memory. The memory 22 stores data to be used for the operations of the control apparatus 20 and data obtained by the operations of the control apparatus 20.

The communication interface 23 includes at least one interface for communication. The interface for communication is, for example, a LAN interface. The communication interface 23 receives data to be used for the operations of the control apparatus 20, and transmits data obtained by the operations of the control apparatus 20.

The input interface 24 includes at least one interface for input. The interface for input is, for example, a physical key, a capacitive key, a pointing device, a touch screen integrally provided with a display, or a microphone. The input interface 24 accepts an operation for inputting data to be used for the operations of the control apparatus 20. The input interface 24, instead of being included in the control apparatus 20, may be connected to the control apparatus 20 as an external input device. As the connection method, any technology such as USB, HDMI® (HDMI is a registered trademark in Japan, other countries, or both), or Bluetooth® (Bluetooth is a registered trademark in Japan, other countries, or both) can be used. The term “USB” is an abbreviation of Universal Serial Bus. The term “HDMI®” is an abbreviation of High-Definition Multimedia Interface.

The output interface 25 includes at least one interface for output. The interface for output is, for example, a display or a speaker. The display is, for example, an LCD or an organic EL display. The term “LCD” is an abbreviation of liquid crystal display. The term “EL” is an abbreviation of electro luminescence. The output interface 25 outputs data obtained by the operations of the control apparatus 20. The output interface 25, instead of being included in the control apparatus 20, may be connected to the control apparatus 20 as an external output device. As the connection method, any technology such as USB, HDMI®, or Bluetooth® can be used.

The functions of the control apparatus 20 are realized by execution of a control program according to the present embodiment by a processor serving as the controller 21. That is, the functions of the control apparatus 20 are realized by software. The control program causes a computer to execute the operations of the control apparatus 20, thereby causing the computer to function as the control apparatus 20. That is, the computer executes the operations of the control apparatus 20 in accordance with the control program to thereby function as the control apparatus 20.

The program can be stored in a non-transitory computer readable medium. The non-transitory computer readable medium is, for example, flash memory, a magnetic recording device, an optical disc, a magneto-optical recording medium, or ROM. The program is distributed, for example, by selling, transferring, or lending a portable medium such as an SD card, a DVD, or a CD-ROM in which the program is stored. The term “SD” is an abbreviation of Secure Digital. The term “DVD” is an abbreviation of digital versatile disc. The term “CD-ROM” is an abbreviation of compact disc read only memory. The program may be distributed by storing the program in a storage of a server and transferring the program from the server to another computer. The program may be provided as a program product.

For example, the computer temporarily stores, in a main memory, a program stored in a portable medium or a program transferred from a server. Then, the computer reads the program stored in the main memory using a processor, and executes processes in accordance with the read program using the processor. The computer may read a program directly from the portable medium, and execute processes in accordance with the program. The computer may, each time a program is transferred from the server to the computer, sequentially execute processes in accordance with the received program. The processes may be executed through a so-called ASP type service that realizes functions merely by execution of instructions and acquisition of results, without transferring the program from the server to the computer. The term “ASP” is an abbreviation of application service provider. Programs encompass information that is to be used for processing by an electronic computer and is thus equivalent to a program. For example, data that is not a direct command to a computer but has a property that regulates processing of the computer is “equivalent to a program” in this context.

Some or all of the functions of the control apparatus 20 may be realized by a dedicated circuit serving as the controller 21. That is, some or all of the functions of the control apparatus 20 may be realized by hardware.

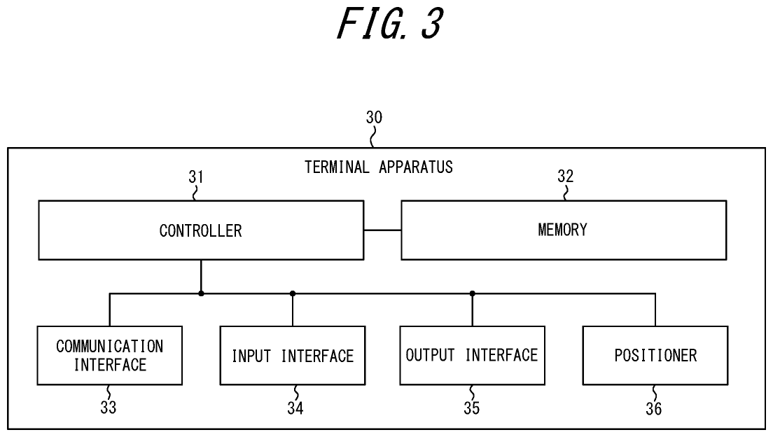

With reference to FIG. 3, a configuration of the terminal apparatus 30 according to the present embodiment will be described.

The terminal apparatus 30 includes a controller 31, a memory 32, a communication interface 33, an input interface 34, an output interface 35, and a positioner 36.

The controller 31 includes at least one processor, at least one programmable circuit, at least one dedicated circuit, or a combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 31 executes processes related to operations of the terminal apparatus 30 while controlling components of the terminal apparatus 30.

The memory 32 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 32 functions as, for example, a main memory, an auxiliary memory, or a cache memory. The memory 32 stores data to be used for the operations of the terminal apparatus 30 and data obtained by the operations of the terminal apparatus 30.

The communication interface 33 includes at least one interface for communication. The interface for communication is, for example, an interface compliant with a mobile communication standard such as LTE, the 4G standard, or the 5G standard, an interface compliant with a short-range wireless communication standard such as Bluetooth®, or a LAN interface. The term “LTE” is an abbreviation of Long Term Evolution. The term “4G” is an abbreviation of 4th generation. The term “5G” is an abbreviation of 5th generation. The communication interface 33 receives data to be used for the operations of the terminal apparatus 30, and transmits data obtained by the operations of the terminal apparatus 30.

The input interface 34 includes at least one interface for input. The interface for input is, for example, a physical key, a capacitive key, a pointing device, a touch screen integrally provided with a display, or a microphone. The input interface 34 accepts an operation for inputting data to be used for the operations of the terminal apparatus 30. The input interface 34, instead of being included in the terminal apparatus 30, may be connected to the terminal apparatus 30 as an external input device. As the connection method, any technology such as USB, HDMI®, or Bluetooth® can be used.

The output interface 35 includes at least one interface for output. The interface for output is, for example, a display or a speaker. The display is, for example, an LCD or an organic EL display. The output interface 35 outputs data obtained by the operations of the terminal apparatus 30. The output interface 35, instead of being included in the terminal apparatus 30, may be connected to the terminal apparatus 30 as an external output device. As the connection method, any technology such as USB, HDMI®, or Bluetooth® can be used.

The positioner 36 includes at least one GNSS receiver. The term “GNSS” is an abbreviation of global navigation satellite system. GNSS is, for example, GPS, QZSS, BeiDou, GLONASS, or Galileo. The term “GPS” is an abbreviation of Global Positioning System. The term “QZSS” is an abbreviation of Quasi-Zenith Satellite System. QZSS satellites are called quasi-zenith satellites. The term “GLONASS” is an abbreviation of Global Navigation Satellite System. The positioner 36 measures the position of the terminal apparatus 30.

The functions of the terminal apparatus 30 are realized by execution of a terminal program according to the present embodiment by a processor serving as the controller 31. That is, the functions of the terminal apparatus 30 are realized by software. The terminal program causes a computer to execute the operations of the terminal apparatus 30, thereby causing the computer to function as the terminal apparatus 30. That is, the computer executes the operations of the terminal apparatus 30 in accordance with the terminal program to thereby function as the terminal apparatus 30.

Some or all of the functions of the terminal apparatus 30 may be realized by a dedicated circuit serving as the controller 31. That is, some or all of the functions of the terminal apparatus 30 may be realized by hardware.

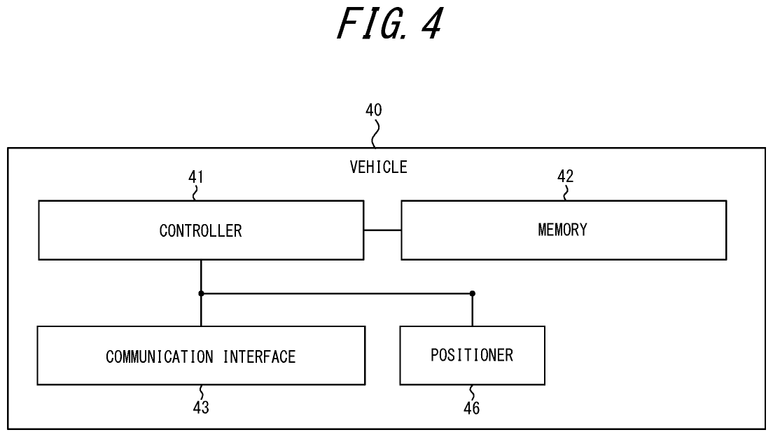

With reference to FIG. 4, a configuration of the vehicle 40 according to the present embodiment will be described.

The vehicle 40 includes a controller 41, a memory 42, a communication interface 43, and a positioner 46.

The controller 41 includes at least one processor, at least one programmable circuit, at least one dedicated circuit, or a combination thereof. The processor is a general purpose processor such as a CPU or a GPU, or a dedicated processor that is dedicated to specific processing. The programmable circuit is, for example, an FPGA. The dedicated circuit is, for example, an ASIC. The controller 41 executes processing related to operations of the vehicle 40 while controlling functional components of the vehicle 40.

The memory 42 includes at least one semiconductor memory, at least one magnetic memory, at least one optical memory, or a combination of at least two of these. The semiconductor memory is, for example, RAM or ROM. The RAM is, for example, SRAM or DRAM. The ROM is, for example, EEPROM. The memory 42 functions as, for example, a main memory, an auxiliary memory, or a cache memory. The memory 42 stores data to be used for the operations of the vehicle 40 and data obtained by the operations of the vehicle 40.

The communication interface 43 includes at least one interface for communication. The interface for communication is, for example, a LAN interface. The communication interface 43 receives data to be used for the operations of the vehicle 40, and transmits data obtained by the operations of the vehicle 40.

The positioner 46 includes at least one GNSS receiver. GNSS is, for example, GPS, QZSS, BeiDou, GLONASS, or Galileo. The positioner 46 measures a position of the vehicle 40.

With reference to FIG. 5, operations of the system 10 according to the present embodiment will be described. These operations correspond to a control method according to the present embodiment.

In the following description, suppose that the first user X has already checked-in at the accommodation facility 60. Suppose that the first user X is attending a meeting held at the conference center 70. Suppose that the vehicle 40 of the first user X is parked in the parking lot 80 annexed to the conference center 70.

In Step S101, the controller 21 of the control apparatus 20 identifies a first time at which the first user X checked-in at the accommodation facility 60 and a second time at which the first user X is to check-out from the accommodation facility 60.

In the present embodiment, the check-in time as the first time and the check-out time as the second time may be identified by any method. one example, when the first user X checks-in at the accommodation facility 60, check-in data is transmitted from the management apparatus 90 installed in the accommodation facility 60 to the control apparatus 20, the check-in data indicating: the time at which the check-in was performed; the first user X; and the check-out time. The controller 21 receives the check-in data via the communication interface 23 and stores the check-in data in the memory 22.

The controller 21 of the control apparatus 20 determines whether the first user X has left the accommodation facility 60 and is staying at another location. The determination of whether the first user X has left the accommodation facility 60 and is staying at another location may be made by any method. As one example, the controller 21 monitors the position of the vehicle 40 of the first user X who has checked-in at the accommodation facility 60, and determines that the first user X has left the accommodation facility 60 and is staying at another location in a case in which the position of the vehicle 40 differs from the position of the accommodation facility 60 and does not change for a certain period of time.

When the controller 21 of the control apparatus 20 determines that the first user X has left the accommodation facility 60 and is staying at another location, the controller 21 of the control apparatus 20 acquires, in Step S102, first positional data that indicates the position of the first user X. The first positional data may be acquired by any method. In the present embodiment, the controller 21 acquires, as the first positional data, data that indicates the position of the vehicle 40 of the first user X. Specifically, the controller 21 receives, from the vehicle 40 via the communication interface 23, data that indicates the position measured by the positioner 46 of the vehicle 40.

In this manner, the controller 21 acquires, as the first positional data, data that indicates a position of the first user X after the first user X left the accommodation facility 60 during the period P from the first time to the second time. The controller 21 stores the acquired first positional data in the memory 22.

In Step S103, the controller 21 of the control apparatus 20 predicts, according to a distance from the position indicated by the first positional data acquired in Step S102 to the accommodation facility 60, a return time at which the first user X is to return to the accommodation facility 60. Specifically, the controller 21 reads the first positional data acquired in Step S102 from the memory 22. Suppose that the distance from the position indicated by the first positional data to the accommodation facility 60 is [L] km. Suppose that a reference speed of the vehicle 40 is [V] km/hour. The controller 21 calculates, based on the distance [L] km and the reference speed [V] km/hour for the vehicle 40, a necessary time to travel from the conference center 70 to the accommodation facility 60 as {[L]/[V]} hours. The controller 21 predicts the return time, based on the calculated necessary time. For example, the controller 21 predicts, as the return time, a time after a lapse of {[L]/[V]} hours, which is the calculated necessary time, from a time at which the first positional data was acquired.

In Step S104, the controller 21 of the control apparatus 20 estimates, as the vacant time period, a time period up to the return time calculated in Step S103.

In this manner, the controller 21 of the control apparatus 20 acquires the first positional data that indicates a position of the first user X, and estimates the vacant time period based on the acquired first positional data.

In Step S105, the communication interface 23 of the control apparatus 20 transmits, to the terminal apparatus 30 of at least one second user Y different from the first user X, vacancy data that indicates the vacant time period estimated in Step S104.

In the present embodiment, the controller 21 of the control apparatus 20 acquires second positional data that indicates a position of one or more users different from the first user X. The controller 21 selects the second user Y from among the one or more users, based on the acquired second positional data. The second positional data may be acquired by any method. In the present embodiment, the controller 21 of the control apparatus 20 acquires, as the second positional data, data that indicates a position measured by a terminal apparatus held by the one or more users. The controller 21 calculates a distance from the position indicated by the second positional data to the accommodation facility 60. The controller 21 predicts an arrival time at which the one or more users are each to arrive at the accommodation facility 60, based on the time at which the second positional data was acquired and the calculated distance. In a case in which a possible arrival time at which a certain user is to arrive at the accommodation facility 60 is on and after the end time of the vacant time period, such user cannot use the vacant time period. Thus, it can be considered that there is no need to notify the user of the vacant time period. Accordingly, in a case in which the possible arrival time predicted for a certain user is earlier than the end time of the vacant time period indicated by the vacancy data, the controller 21 selects such user as the second user Y.

As another method for selecting the second user Y, the controller 21 of the control apparatus 20 may select the second user Y according to a distance D1 from the position indicated by the first positional data acquired in Step S102 to the accommodation facility 60 and a distance D2 from the position indicated by the second positional data to the accommodation facility 60. For example, in a case in which the distance D1 is longer than the distance D2 for a certain user, such user can arrive at the accommodation facility 60 before the first user X returns to the accommodation facility 60. Thus, such user is considered to be able to use the accommodation facility 60 until the first user X returns to the accommodation facility 60. Accordingly, in a case in which the distance D1 is longer than the distance D2 measured for a certain user, the controller 21 selects such user as the second user Y.

The controller 31 of the terminal apparatus 30 receives, via the communication interface 33, the vacancy data transmitted from the control apparatus 20, and displays the vacancy data on the output interface 35 such as a display. The start time and end time of the vacant time period, the name and location of the accommodation facility 60, a route to the location, and the contact information for the accommodation facility 60, which are indicated by the vacancy data, are displayed, for example, as text on the output interface 35.

The controller 31 of the terminal apparatus 30 receives, via the input interface 34 such as a touch screen, an operation made by the second user Y to apply for use during the vacant time period indicated by the vacancy data. The operation made by the second user Y to apply for use during the vacant time period may be performed by any method. As one method, for example, the second user Y may perform a GUI operation such as pressing an “apply” button to be displayed along with the vacancy data displayed in text on the output interface 35. The term “GUI” is an abbreviation of graphical user interface.

The controller 31 of the terminal apparatus 30 generates application data to apply for use of the accommodation facility 60 during the vacant time period by the second user Y. The controller 31 controls the communication interface 33 to transmit the application data. The communication interface 33 transmits the application data to the control apparatus 20. The controller 21 of the control apparatus 20 receives, via the communication interface 23, the application data transmitted from the communication interface 33 of the terminal apparatus 30. In this manner, the communication interface 23 of the control apparatus 20 receives, from the terminal apparatus 30, as a response to the vacancy data, application data to apply for use during the vacant time period.

Upon acquiring the application data, the controller 21 of the control apparatus 20 presents the contents of the application data received by the communication interface 23 to a manager of the accommodation facility 60. Specifically, the controller 21 transmits, via the communication interface 23, application data to apply for use during the vacant time period, to the management apparatus 90 installed in the accommodation facility 60. The controller 21 transmits the application data to a reservation management server as the management apparatus 90. The management apparatus 90 of the accommodation facility 60 stores the received application data and displays the data on a display or the like.

As described above, the controller 21 of the control apparatus 20 performs the processes of Steps S101 to S104 to estimate a vacant time period, which is a time period during which the accommodation facility 60 is not used by the first user X in a period P from a first time at which the first user X checked-in at the accommodation facility 60 to a second time at which the first user X is to check-out from the accommodation facility 60. The controller 21 performs the process of Step S105 to transmit the vacancy data that indicates the estimated vacant time period, to the terminal apparatus 30 of at least one second user Y different from the first user X.

The present embodiment enables to make effective use of the vacant time period of the accommodation facility 60.

The controller 21 of the control apparatus 20 may present the content of the application data to the first user X instead of transmitting the content of the application data to the management apparatus 90 of the accommodation facility 60. In such a variation, the controller 21 transmits, via the communication interface 23, application data to apply for use during the vacant time period to a terminal apparatus T of the first user X. The terminal apparatus T receives the application data and displays the application data on a display or the like. The terminal apparatus T accepts an operation made by the first user X to approve an application from the second user Y indicated by the received application data. The terminal apparatus T transmits data that indicates the approval of the first user X, to the terminal apparatus 30 of the second user Y.

The present variation enables the first user X to sublease the room to the second user Y, that is, to allow the second user Y to use the room during the vacant time period, without any intervention to be made by a manager of the accommodation facility 60. The first user X may collect a usage fee from the second user Y, which means that the first user X can recover a part of his or her accommodation fee. Therefore, the accommodation cost that the first user X needs to pay is reduced.

As another method for predicting the return time, the controller 21 of the control apparatus 20 may, in Step S102, predict the return time according further to an attribute of the position indicated by the first positional data. In such a variation, the controller 21 estimates a length of stay by the first user X at the position indicated by the first positional data, according to the attribute. The controller 21 predicts the return time by adding the estimated length of stay to the calculated necessary time. In the present variation, the “attribute” is a type of a facility F that exists at a position indicated by the first positional data. The type of the facility F may include, for example, a conference facility, a dining facility, or a sightseeing spot. The attribute may be identified by any method. As one example, suppose that information about a facility that exists at a position indicated by the first positional information is attached, as meta information, to the first positional data. The controller 21 refers to such meta information, to thereby identify the type of the facility that exists at the position, as the attribute of the position.

In Step S103, the controller 21 of the control apparatus 20 calculates a necessary time to travel from the conference center 70 to the accommodation facility 60, and estimates a length of stay at the conference center 70 according to the type of the facility F. The length of stay may be estimated by any method. As one example, the controller 21 refers to a database in which a standard length of stay is set for each type of the facility F, and estimates the length of stay. The database is constructed to have a table illustrated in, for example, FIG. 6, which indicates correspondences between attributes and the lengths of stay. In the table illustrated in FIG. 6, the length of stay corresponding to a conference facility as the attribute is 3 hours, the length of stay to a dining facility is 2 hours, and the length of stay to a sightseeing spot is 1 hour. The standard length of stay is not limited to the examples illustrated in FIG. 6, and may be set arbitrarily. The controller 21 refers to the table illustrated in FIG. 6 and estimates the length of stay corresponding to the identified attribute. The controller 21 predicts the return time by adding the estimated length of stay to the calculated necessary time. For example, suppose that the type of the facility F identified as the attribute is a sightseeing spot. The controller 21 refers to the table illustrated in FIG. 6 and estimates that the length of stay is 1 hour. The controller 21 predicts, as the return time, a time after a lapse of [{L]/}V] hours+1 hour}, which is the time obtained by adding 1 hour as the length of stay to the [L]/[V] hours calculated as the necessary time, from a time at which the first positional data was acquired.

The present variation enables to predict the return time more accurately.

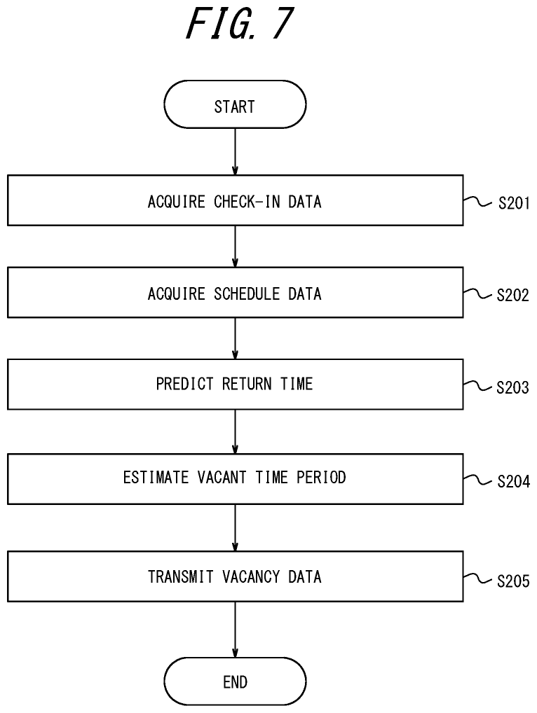

As a variation of the first embodiment, the controller 21 of the control apparatus 20 may acquire schedule data that indicates a schedule for the first user X, and estimate a vacant time period based on the acquired schedule data. With reference to FIG. 7, a second embodiment as such a variation will be described.

Of the operations of the system 10 of the present embodiment, the processes of Step S201, Step S204, and Step S205 illustrated in FIG. 7 are the same as the processes of Step S101, Step S104, and Step S105 illustrated in FIG. 5, respectively, and thus the descriptions thereof are omitted.

In Step S202, the controller 21 of the control apparatus 20 acquires schedule data that indicates a schedule for the first user X. The schedule data may be acquired at any timing, but in the present embodiment, the schedule data is acquired at a timing when the first user X checked-in at the accommodation facility 60. Specifically, the controller 21 acquires the schedule data at a timing when the check-in data is received from the management apparatus 90. The schedule data for the first user X may be acquired by any method. As one example, the controller 21 of the control apparatus 20 refers to a database in which the schedule data for the first user X is stored in advance, and acquires a schedule for the first user X. Alternatively, the controller 21 generates a message for inquiring about the schedule for the first user X, and transmits the generated message to the terminal apparatus T of the first user X via the communication interface 23. The controller 21 may acquire, as the schedule data, a response received from the first user X in response to the transmitted message. The schedule data may be input by the first user X. The controller 21 stores the acquired schedule data in the memory 22.

The schedule data for the first user X includes data that indicates the venue and holding time period for an event in which the first user X is to participate. Examples of the event in which the first user X is to participate include a meeting, a sightseeing, or a dinner. In the following explanation, suppose that the event indicated by the schedule data is a “dinner”. Suppose that the event will be held at “Restaurant PP”. Suppose that the distance from the restaurant PP to the accommodation facility 60 is [M] km. Suppose that the holding time period for the dinner is from 19:00 to 21:00.

In Step S203, the controller 21 of the control apparatus 20 predicts, according to a distance from the venue for the event indicated by the acquired schedule data to the accommodation facility 60, a return time at which the first user X is to return to the accommodation facility 60 after the holding time period for the event indicated by the schedule data. The controller 21 reads the schedule data acquired in Step S201 from the memory 22. According to the read schedule data, the controller 21 calculates, based on the distance [M] km from the restaurant PP to the accommodation facility 60 indicated as the venue for the event and the reference speed [V] km/hour for the vehicle 40, a necessary time to travel by the vehicle 40 from the restaurant PP to the accommodation facility 60, as {[M]/[V]} hours. The controller 21 estimates, as the return time, a time after a lapse of {[M]/[V]} hours from 21:00, which is the end time of the dinner.

The present embodiment enables to estimate the vacant time period even before the first user X leaves the accommodation facility 60. In addition, the return time can be predicted more accurately.

As a variation of the present embodiment, the controller 21 of the control apparatus 20 may predict, according to a distance from the venue for the event to the accommodation facility 60, a departure time at which the first user X is to leave the accommodation facility 60 prior to the holding time period indicated by the schedule data, and estimate, as the vacant time period, a time period starting from the predicted departure time. Specifically, in Step S203, the controller 21 calculates, based on the distance [M] km from the restaurant PP indicated as the venue for the event by the schedule data read in

Step S202 to the accommodation facility 60 and the reference speed [V] km/hour for the vehicle 40, a necessary time to travel by the vehicle 40 from the accommodation facility 60 to the restaurant PP as {[M]/[V]} hours. The controller 21 estimates, as the departure time, a time {[M]/[V] } hours before 19:00, which is the start time of the dinner.

In Step S204, the controller 21 of the control apparatus 20 estimates, as the vacant time period, the time period starting from the departure time calculated in Step S203.

The present variation enables to present the vacancy data to the second user Y prior to a time from which the vacant time period of the accommodation facility 60 starts. Therefore, the second user Y can readily plan the use during the vacant time period.

The present disclosure is not limited to the embodiments described above. For example, a plurality of blocks described in the block diagrams may be integrated, or a block may be divided. Instead of executing a plurality of steps described in the flowcharts in chronological order in accordance with the description, the plurality of steps may be executed in parallel or in a different order according to the processing capability of the apparatus that executes each step, or as required. Other modifications can be made without departing from the spirit of the present disclosure.

As a variation of the present embodiment, the controller 21 of the control apparatus 20 may acquire the positional data for the terminal apparatus T of the first user X as the first positional data, instead of acquiring the positional data for the vehicle 40 of the first user X. According to the present variation, in a case in which the first user X has reserved a guest room of a hotel as the accommodation facility 60, the time period starting from a time at which the first user X left the room until the time at which the first user X returns to the room is estimated as the “vacant time period”. Thus, even in a case in which the first user X is outside the guest room but staying at a location different from the guest room or in a case in which the first user X has gone out by any other mode than the vehicle 40, the vacant time period can still be estimated. Therefore, the vacant time period can be estimated more accurately.

1. A control apparatus, comprising:
a controller configured to estimate a vacant time period during a period from a first time at which a first user checked-in at an accommodation facility to a second time at which the first user is to check-out from the accommodation facility, the vacant time period being a time period during which the accommodation facility is not used by the first user; and
a communication interface configured to transmit vacancy data that indicates the vacant time period estimated by the controller, to a terminal apparatus of at least one second user that is different from the first user.

2. The control apparatus according to claim 1, wherein the controller is configured to: acquire first positional data that indicates a position of the first user; and estimate the vacant time period based on the acquired first positional data.

3. The control apparatus according to claim 2, wherein the controller is configured to: acquire, as the first positional data, data that indicates a position of the first user after the first user left the accommodation facility during the period; predict, according to a distance from the position indicated by the first positional data to the accommodation facility, a return time at which the first user is to return to the accommodation facility; and
estimate, as the vacant time period, a time period up to the predicted return time.

4. The control apparatus according to claim 3, wherein the controller is configured to predict the return time according further to an attribute of the position indicated by the first positional data.

5. The control apparatus according to claim 1, wherein the controller is configured to: acquire schedule data that indicates a schedule for the first user; and estimate the vacant time period based on the acquired schedule data.

6. The control apparatus according to claim 5, wherein the schedule data includes data that indicates a venue and holding time period for an event in which the first user is to participate, and
the controller is configured to: predict, according to a distance from the venue for the event to the accommodation facility, a return time at which the first user is to return to the accommodation facility after the holding time period indicated by the schedule data; and estimate, as the vacant time period, a time period up to the predicted return time.

7. The control apparatus according to claim 6, wherein the controller is configured to predict, according to a distance from the venue for the event to the accommodation facility, a departure time at which the first user is to leave the accommodation facility prior to the holding time period indicated by the schedule data; and estimate, as the vacant time period, a time period starting from the predicted departure time.

8. The control apparatus according to claim 1, wherein the controller is configured to: acquire second positional data that indicates a position of one or more users different from the first user; and select the second user from among the one or more users, based on the acquired second positional data.

9. The control apparatus according to claim 8, wherein the controller is configured to: acquire first positional data that indicates a position of the first user after the first user left the accommodation facility during the period; and select the second user, according to a distance from the position indicated by the acquired first positional data to the accommodation facility and a distance from the position indicated by the second positional data to the accommodation facility.

10. The control apparatus according to claim 1, wherein the communication interface is configured to receive, from the terminal apparatus, as a response to the vacancy data, application data to apply for use during the vacant time period, and
the controller is configured to present contents of the application data received by the communication interface to a manager of the accommodation facility.

11. A system, comprising:
the control apparatus according to claim 1; and
a terminal apparatus configured to: receive the vacancy data from the control apparatus; and present contents of the vacancy data to the second user.

12. A control method, comprising:
estimating, by a control apparatus, a vacant time period during a period from a first time at which a first user checked-in at an accommodation facility to a second time at which the first user is to check-out from the accommodation facility, the vacant time period being a time period during which the accommodation facility is not used by the first user; and
transmitting, from the control apparatus, vacancy data that indicates the estimated vacant time period, to a terminal apparatus of at least one second user that is different from the first user.

13. The control method according to claim 12, further comprising acquiring, by the control apparatus, first positional data that indicates a position of the first user,
wherein the estimating is performed based on the acquired first positional data.

14. The control method according to claim 13, wherein
the acquiring includes acquiring data that indicates a position of the first user after the first user left the accommodation facility during the period, and
the estimating includes predicting, according to a distance from the position indicated by the first positional data to the accommodation facility, a return time at which the first user is to return to the accommodation facility and estimating, as the vacant time period, a time period up to the predicted return time.

15. The control method according to claim 12, further comprising acquiring, by the control apparatus, schedule data that indicates a schedule for the first user,
wherein the estimating is performed based on the schedule data.

16. The control method according to claim 15, wherein the schedule data includes data that indicates a venue and holding time period for an event in which the first user is to participate, and
the estimating includes predicting, according to a distance from the venue for the event to the accommodation facility, a return time at which the first user is to return to the accommodation facility after the holding time period indicated by the schedule data, and estimating, as the vacant time period, a time period up to the predicted return time.

17. The control method according to claim 16, wherein the estimating further includes predicting, according to a distance from the venue for the event to the accommodation facility, a departure time at which the first user is to leave the accommodation facility prior to the holding time period indicated by the schedule data, and estimating, as the vacant time period, a time period starting from the predicted departure time.

18. The control method according to claim 12, further comprising:
acquiring, by the control apparatus, second positional data that indicates a position of one or more users different from the first user; and
selecting, by the control apparatus, the second user from among the one or more users, based on the acquired second positional data.

19. The control method according to claim 18, further comprising:
acquiring, by the control apparatus, first positional data that indicates a position of the first user after the first user left the accommodation facility during the period,
wherein the selecting includes selecting the second user according to a distance from the position indicated by the first positional data to the accommodation facility and a distance from the position indicated by the second positional data to the accommodation facility.

20. The control method according to claim 12, further comprising:
receiving, by the control apparatus, application data to apply for use during the vacant time period, the application data having been transmitted from the terminal apparatus as a response to the vacancy data; and
presenting, by the control apparatus, contents of the received application data to a manager of the accommodation facility.
